(19) United States
(12) Patent Application Publication
(10) Pub. No.: US 2005/0118421 A1
(43) Pub. Date: Jun. 2, 2005

(54) Electrophotographic conductive member and electrophotographic apparatus

(75) Inventors: Tsunenori Ashibe, Kanagawa (JP); Ryota Kashiwabara, Shizuoka (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/995,358

(22) Filed: Nov. 24, 2004

(30) Foreign Application Priority Data
Nov. 28, 2003 (JP) 2003-399886

(51) Int. Cl. G03G 15/02

(52) U.S. Cl. 428/364

(57) ABSTRACT

In an electrophotographic conductive member composed of at least a thermoplastic resin composition, the thermoplastic resin composition contains a thermoplastic resin, a conductive filler and a conductive-filler dispersing agent, and the conductive-filler dispersing agent is a polyhydric alcohol type nonionic surface-active agent.

### BACKGROUND OF THE INVENTION

1. Field of the Invention

This invention relates to an electrophotographic conductive member such as a charging member, a developer carrying member, an intermediate transfer member or a transfer material transporting member, and an electrophotographic apparatus having the electrophotographic conductive member.

2. Related Background Art

Various systems such as an electrophotographic system, a thermal transfer system and an ink-jet system have conventionally been employed in image forming apparatus. Of these, an image forming apparatus employing the electrophotographic system, what is called an electrophotographic apparatus, has superiority to image forming apparatus employing other systems, in view of high speed, high image quality and noiselessness.

The electrophotographic system is a system in which, the surface of an electrophotographic photosensitive member is primarily electrostatically charged (a primary charging step), thereafter an electrostatic latent image is formed on the surface of the electrophotographic photosensitive member by exposure (an exposure step), this electrostatic latent image is developed with a toner to form a developed image (a developing step), and thereafter this developed image is transferred to a transfer material (a transfer step). In the primary charging step or the transfer step, a charging member such as a primary charging roller or a transfer charging roller is used. In the developing step, a developer carrying member such as a developing roller is used.

In addition, not only monochrome electrophotographic apparatus, but also polychrome (color) electrophotographic apparatus (color electrophotographic apparatus) have come popular.

Various systems are employed in such color electrophotographic apparatus. For example, well known are an intermediate transfer system in which primary charging, exposure and development are successively performed for each color by means of a single electrophotographic photosensitive member, and respective-color toner images are primarily sequentially transferred onto an intermediate transfer member (such as an intermediate transfer drum or an intermediate transfer belt), where the toner images thus transferred are thereafter secondarily transferred in a lump onto a transfer material to form a color image; and an in-line system in which respective-color toner images are respectively formed in respective-color image forming sections disposed in series (each having an electrophotographic photosensitive member, a primary charging means, an exposure means, a developing means, a transfer means and so forth), and the toner images thus formed are sequentially transferred to a transfer material coming transported to the respective image forming sections in turn, to form a color image.

The color electrophotographic apparatus of an intermediate transfer system has an advantage that transfer materials can be selected in great variety without regard to differences in width, length and thickness of transfer materials because it is unnecessary to process or control the transfer material (such as paper), e.g., hold it on a gripper, attract it to the electrophotographic photosensitive member or make it have a curvature. The color electrophotographic apparatus of an in-line system also has an advantage that a color image is formed through one step and images can be reproduced at a high speed.

However, these electrophotographic conductive members such as a charging member, a developer carrying member, an intermediate transfer member and a transfer material transporting member have such technical problems as discussed below.

The electrophotographic conductive members such as a charging member, a developer carrying member, an intermediate transfer member and a transfer material transporting member are commonly produced using thermoplastic resin compositions. Also, in providing the electrophotographic conductive members with conductivity, a method is commonly used in which a conductive filler is dispersed in the thermoplastic resin composition, where, however, the conductive filler may agglomerate when the conductive filler has a surface energy higher than the surface energy of the thermoplastic resin in the thermoplastic resin composition.

If the conductive filler agglomerates, the conductive filler may have a poor dispersibility to cause density non-uniformity of the conductive filler in the thermoplastic resin composition. This makes electrical resistance of the electrophotographic conductive members unstable and makes any desired electrical resistance unachievable. Also, if the density non-uniformity of the conductive filler comes in the thermoplastic resin composition to cause pimples or the like on the surfaces of the electrophotographic conductive members, faulty reproduced images due to the pimples may appear or a leak due to the pimples may occur. In such a case, satisfactory products may be obtained with difficulty or the yield may come poor, resulting in a high production cost.

As a countermeasure for these, Japanese Patent Application Laid-open No. H03-089357 discloses a technique in which a conductive filler and every kind of dispersing agent (such as wax) are mixed.

However, the technique disclosed in Japanese Patent Application Laid-open No. H03-089357 requires the dispersing agent in an amount equal to or more than the amount of the conductive filler to be used. For example, where the electrophotographic conductive members should be made to have conductivity at desired values, the amounts of the conductive filler and dispersing agent in total may inevitably come close to about a half of the amount of the thermoplastic resin composition. This has, in some cases, caused a great lowering of physical properties of the thermoplastic resin composition or the electrophotographic conductive members making use of the same.

A cationic surface-active agent is also available as a dispersing agent that may well be added in a small quantity. The cationic surface-active agent, however, tends to bleed, and hence the electrophotographic conductive members may change in electrical resistance of their surfaces, or some bled matter may contaminate the electrophotographic photosensitive member or the bled matter may cause break of the electrophotographic photosensitive member at its surface. This has caused faulty reproduced images in some cases.

### SUMMARY OF THE INVENTION

An object of the present invention is to provide at a low cost a high-quality electrophotographic conductive member having solved the above technical problems, and an electrophotographic apparatus having such an electrophotographic conductive member.

That is, the present invention is an electrophotographic conductive member composed of at least a thermoplastic resin composition, wherein;

the thermoplastic resin composition contains a thermoplastic resin, a conductive filler and a conductive-filler dispersing agent, and the conductive-filler dispersing agent is a polyhydric alcohol type nonionic surface-active agent.

The present invention is also an electrophotographic apparatus having the above electrophotographic conductive member

### BRIEF DESCRIPTION OF THE DRAWINGS

FIG. 1 is a schematic view showing an example of the construction of an apparatus for producing an electrophotographic endless belt, which employs a blown-film extrusion (inflation) method.

FIG. 2 is a schematic view showing another example of the construction of an apparatus for producing an electrophotographic endless belt, which employs a blown-film extrusion (inflation) method.

FIG. 3 is a schematic view showing an example of the construction of an electrophotographic apparatus.

FIG. 4 is a schematic view showing an example of the construction of an intermediate transfer type color electrophotographic apparatus.

FIG. 5 is a schematic view showing an example of the construction of an in-line type color electrophotographic apparatus.

FIG. 6 is a schematic view showing another example of the construction of the intermediate transfer type color electrophotographic apparatus.

FIG. 7 is a view showing spots at which volume resistivity and surface resistivity are measured.

### DESCRIPTION OF THE PREFERRED EMBODIMENTS

The electrophotographic conductive member of the present invention is formed of a thermoplastic resin composition containing a conductive filler and a conductive-filler dispersing agent comprising a polyhydric alcohol type nonionic surface-active agent.

The use of the polyhydric alcohol type nonionic surface-active agent as the conductive-filler dispersing agent enables reduction of surface activity of the conductive filler, control of agglomeration of the conductive filler and stabilization of dispersion of the conductive filler, and hence enables prevention of electrical-resistance non-uniformity, faulty reproduced images and leak which are due to faulty dispersion of the conductive filler.

The polyhydric alcohol type nonionic surface-active agent as the conductive-filler dispersing agent also brings out a conductive filler dispersion stabilization effect by its use in a small quantity. Hence, the bleeding of the dispersing agent can not easily occur, and neither changes in surface resistance of the electrophotographic conductive member nor contamination of the electrophotographic photosensitive member may occur. Moreover, even where the bleeding has occurred slightly, the surface of the electrophotographic photosensitive member can not easily break.

The polyhydric alcohol type nonionic surface-active agent used in the present invention may include glycerol fatty esters, pentaerythritol fatty esters, sorbitol fatty esters and sorbitan fatty esters. Of these, glycerol fatty esters are preferred. Of the glycerol fatty esters, polyglycerol poly-ricinolate and polyglycerol stearate are more preferred.

The polyglycerol poly-ricinolate and the polyglycerol stearate, both having high decomposition temperatures (295° C. and 273° C., respectively), are usable in resin compositions making use of commonly available thermoplastic resins. The polyglycerol poly-ricinolate and the polyglycerol stearate also have a very high safety.

The thermoplastic resin which is a chief material of the thermoplastic resin composition used in the electrophotographic conductive member of the present invention may include olefin resins such as polyethylene and polypropylene, polystyrene resins, acrylic resins, polyester resins, polycarbonate resins, sulfur-atom-containing resins such as polysulfone, polyether sulfone and polyphenylene sulfide, fluorine-atom-containing resins such as polyvinylidene fluoride and a polyethylene-tetrafluoroethylene copolymer, polyurethane resins, silicone resins, ketone resins, polyvinylidene chloride, thermoplastic polyimide resins, polyamide resins, modified polyphenylene oxide resins, vinyl acetate resins, phenolic resins, epoxy resins, ABS resins, ionomer resins, acrylic resins, polyvinyl alcohol (PVA), polyvinyl butyral, an ethylene-vinyl acetate copolymer (EVA), an ethylene-vinyl alcohol copolymer (EVOH), vinylidene chloride resins, and celluloses.

Incidentally, the thermoplastic resin used in the present invention may embrace not only plastic thermoplastic resins but also elastic thermoplastic resins called thermoplastic elastomers.

The conductive filler used in the electrophotographic conductive member of the present invention may include, e.g., carbon black, and particles of graphite, aluminum-doped zinc oxide, titanium oxide coated with tin oxide, tin oxide, barium oxide coated with tin oxide, potassium titanate, aluminum, and nickel. Of these, carbon black is preferred, which can exhibit conductivity in its use in a small quantity, can keep mechanical physical properties of the electrophotographic conductive member from lowering, and has a good compatibility with the polyhydric alcohol type nonionic surface-active agent.

A filler such as barium sulfate or every kind of whisker may also optionally be used.

An ionic conducting agent may also be used in combination, as an auxiliary material which provides the electrophotographic conductive member with conductivity.

The polyhydric alcohol type nonionic surface-active agent may preferably be contained in the thermoplastic resin composition in an amount of from 0.1 to 5.0% by weight based on the total weight of the thermoplastic resin composition, in an amount of from 1 to 20% by weight based on the weight of the conductive filler in the thermoplastic resin composition, and in an amount of from 0.05 to 4.5% by weight based on the weight of the thermoplastic resin in the thermoplastic resin composition. If the polyhydric alcohol type nonionic surface-active agent is used in a too small quantity, the conductive filler dispersion stabilization effect may come poor. If the dispersing agent is used in a too large quantity, the bleeding of the polyhydric alcohol type nonionic surface-active agent may occur or the mechanical physical properties of the electrophotographic conductive member may lower.

The conductive filler may also preferably be contained in the thermoplastic resin composition in an amount of from 2.0 to 60.0% by weight based on the total weight of the thermoplastic resin composition, and in an amount of from 2.0 to 150% by weight based on the weight of the thermoplastic resin in the thermoplastic resin composition. If the conductive filler is used in a too small quantity, the electrophotographic conductive member may have an insufficient conductivity. If the conductive filler is used in a too large quantity, the electrophotographic conductive member may have low mechanical physical properties.

As methods for mixing the conductive filler and the polyhydric alcohol type nonionic surface-active agent, a dry method and a wet method are available. As the dry method, a method is available in which the conductive filler and the polyhydric alcohol type nonionic surface-active agent are mixed by means of every kind of mixer. As the wet method, a method is available in which the polyhydric alcohol type nonionic surface-active agent is diluted with every kind of solvent and the conductive filler is introduced into the resultant dilute solution, followed by removal of the solvent by means of every kind of dryer. The dry method has an advantage that it can enjoy a low cost, and the wet method has an advantage that the polyhydric alcohol type nonionic surface-active agent adheres uniformly to particle surfaces of the conductive filler. Accordingly, the dry method and the wet method may properly be used according to purposes.

As methods for dispersing the conductive filler in the thermoplastic resin by the aid of the polyhydric alcohol type nonionic surface-active agent, available are a method in which it is dispersed by means of every kind of extruder such as a twin-screw extruder or a single-screw extruder, and a method in which it is dispersed by means of every kind of mixer such as a kneader or Banbury mixer or every kind of roll mill such as a two-roll mill or a three-roll mill. The twin-screw extruder is preferred in order to control dispersion. This is because, in the twin-screw extruder, screw construction is changeable with ease, conditions for an adequate dispersed state can be found with ease by changing the screw construction, the throughput and the number of screw revolution can individually be controlled and hence the retention time of the thermoplastic resin can be changed with ease, the state of dispersion can be changed even in the state the screw is not changed, and optimum conditions for dispersion can be found with ease.

The electrophotographic conductive member of the present invention may have the shape of a roller, the shape of a drum, the shape of a blade or the shape of a belt without any particular limitations to the shape. The shape of a roller is preferred when the electrophotographic conductive member of the present invention is used as a charging member or a developer carrying member, and the shape of a belt is preferred when used as an intermediate transfer member or a transfer material transporting member. The shape of a roller is, e.g., the shape in which a roller-shaped support (mandrel) is covered thereon with the thermoplastic resin composition, which has been made up in a tubular form.

The electrophotographic conductive member of the present invention may have volume resistivity and surface resistivity which are selected according to purposes of the electrophotographic conductive member. Where the electrophotographic conductive member of the present invention is used as a charging member, it may preferably have a volume resistivity of from 1×10³ to 1×10¹¹ Ω·cm and a surface resistivity of from 1×10³ to 5×10¹¹ Ω. Where the electrophotographic conductive member of the present invention is used as a developer carrying member, it may preferably have a volume resistivity of from 1×10⁴ to 1×10⁹ Ω·cm and a surface resistivity of from 1×10⁴ to 1×10¹⁰ Ω. Where the electrophotographic conductive member of the present invention is used as an intermediate transfer member, it may preferably have a volume resistivity of from 1×10⁶ to 1×10¹⁴ Ω·cm and a surface resistivity of from 1×10⁶ to 1×10¹⁴ Ω. Where the electrophotographic conductive member of the present invention is used as a transfer material transporting member, it may preferably have a volume resistivity of from 1×10⁷ to 5×10¹⁴ Ω·cm and a surface resistivity of from 1×10⁷ to 1×10¹⁵ Ω.

The electrophotographic conductive member of the present invention may also have volume resistivity and surface resistivity whose maximum values are within 100 times their minimum values in both the peripheral direction and the generatrix direction.

For example, where the electrophotographic conductive member of the present invention is used as a transfer material transporting member or an intermediate transfer member, if the maximum value of the volume resistivity in the peripheral direction is larger than 100 times the minimum value or if the maximum value of the surface resistivity in the peripheral direction is larger than 100 times the minimum value, image non-uniformity may occur in the peripheral direction. Also, where voltage is applied at a plurality of spots (e.g., where transfer voltage is applied at a plurality of spots), electric current may flow from a certain spot at which the voltage is applied, into other spot(s) via a part having a low electrical resistance in the peripheral direction, to disturb voltage control at other spot(s), and this may make any normal operation unachievable.

If the maximum value of the volume resistivity in the generatrix direction is larger than 100 times the minimum value, image non-uniformity may occur in the generatrix direction. Also, excess electrical current may flow into a portion having the minimum volume resistivity, so that the electrophotographic apparatus may misoperate.

If the maximum value of the surface resistivity in the generatrix direction is larger than 100 times the minimum value, image non-uniformity may occur in the generatrix direction. Also, where a cleaning method is employed in which stated electric charges are imparted to a transfer residual toner to return it to the electrophotographic photosensitive member, excess electrical current may flow from a charging member which imparts the electric charges, into a portion having the minimum surface resistivity in the electrophotographic conductive member. At such a portion, no sufficient electric field is applied in its generatrix direction, and hence cleaning non-uniformity may occur in the generatrix direction.

In order to achieve the above requirements for electrical resistance, appropriate adjustment may be made on the mixing proportion of the thermoplastic resin, conductive filler and polyhydric alcohol type nonionic surface-active agent in the thermoplastic resin composition, their compatibility, conditions required when the conductive filler is dispersed, and also conditions required when the electrophotographic conductive member is produced.

Incidentally, the volume resistivity and the surface resistivity show not a mere difference in measuring conditions, but quite different electrical properties.

More specifically, where voltage and electrical current are applied in the thickness direction of the electrophotographic conductive member, the movement of electric charges inside the electrophotographic conductive member depends on the internal structure or physical properties of the electrophotographic conductive member, in other words, the layer configuration of the electrophotographic conductive member and the types, or the state of dispersion, of various additives (such as a resistance control agent). As the result, the surface potential and charge elimination speed of the electrophotographic conductive member are determined.

On the other hand, where voltage and electrical current are applied in such a way that electric charges are delivered and received only at the surface of the electrophotographic conductive member, the surface potential and charge elimination speed are determined by the proportion of presence of the additives (such as a resistance control agent) at the surface of the electrophotographic conductive member, almost without depending on the internal structure or layer configuration of the electrophotographic conductive member.

A method of measuring the volume resistivity and surface resistivity of the electrophotographic conductive member in the present invention is described below, taking the case of a transfer material transporting belt.

Measuring Machine

Resistance meter: Ultra-high resistance meter R8340A (manufactured by Advantest Corporation). Sample box: Sample box TR42 for ultra-high resistance meter (manufactured by Advantest Corporation).

The main electrode is 25 mm in diameter, and the guard-ring electrode is 41 mm in inner diameter and 49 mm in outer diameter.

Sample

The transfer material transporting belt is cut in a circular form of 56 mm in diameter. After cutting, it is provided, on its one side, with an electrode over the whole surface by forming a Pt-Pd deposited film and, on the other side, provided with a main electrode of 25 mm in diameter and a guard electrode of 38 mm in inner diameter and 50 mm in outer diameter by forming Pt-Pd deposited films. The Pt-Pd deposited films are formed by carrying out vacuum deposition for 2 minutes using Mild Sputter E1030 (manufactured by Hitachi Ltd.). The one on which the vacuum deposition has been carried out is used as the sample.

Measurement Conditions

Measurement atmosphere: 23° C., 55% RH.

Here, the measuring sample is previously kept left in a environment of 23° C./55% RH for 12 hours or more.

Measurement mode: Discharge for 10 seconds, and charge and measurement for 30 seconds.

Applied voltage: 100 V.

As the applied voltage, employed is 100 V in 1 to 1,000 V which is the range of the voltage to be applied to the electrophotographic conductive member in the electrophotographic apparatus.

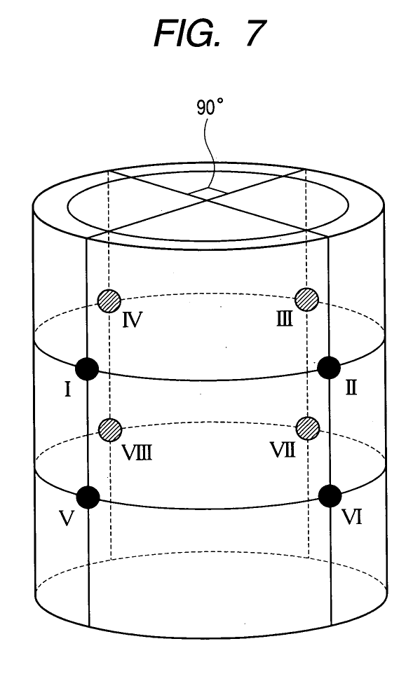

Measurement spots are four spots in the peripheral direction x two spots in the axial direction, eight spots in total. Average values of measured values at the eight spots are regarded as the volume resistivity and surface resistivity of the electrophotographic conductive member (see FIG. 7).

The volume resistivity and surface resistivity of electrophotographic conductive members other than the transfer material transporting belt are also measured in the same manner as the above.

An example of a process for producing the electrophotographic conductive member of the present invention is described, taking the case of a belt-shaped electrophotographic conductive member.

The process for producing the belt-shaped electrophotographic conductive member may include, e.g., extrusion, blown-film extrusion (inflation), injection molding, and blow molding. In particular, blown-film extrusion is preferred.

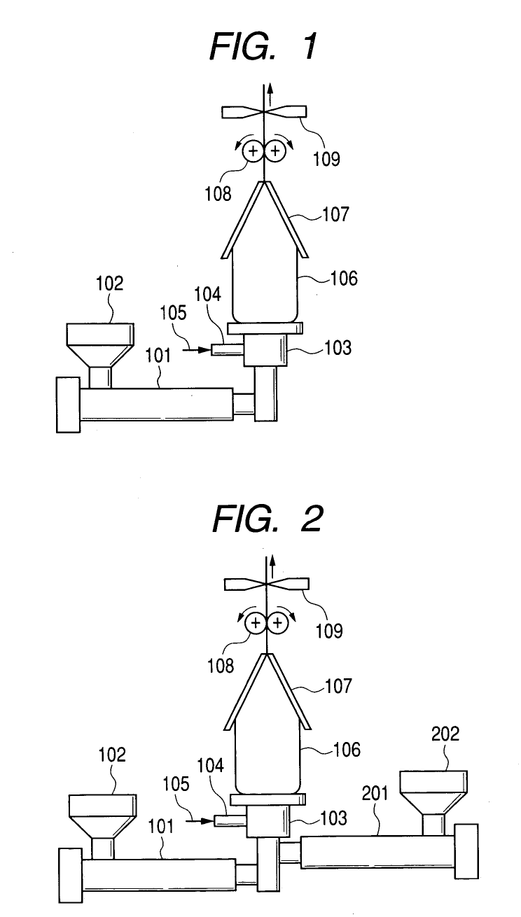

FIG. 1 is a schematic view showing an example of the construction of an apparatus for producing the belt-shaped electrophotographic conductive member, which employs the blown-film extrusion.

First, an extrusion material prepared by premixing the above thermoplastic resin, conductive filler and polyhydric alcohol type nonionic surface-active agent under the stated formulation, followed by kneading and dispersion, is put into an extruder 101 from a hopper 102. Temperature and screw construction in the extruder 101 are so selected that the extrusion material may have a melt viscosity for enabling extrusion into a belt and also the conductive filler is uniformly dispersed in the extrusion material.

The extrusion material is melt-kneaded in the extruder 101 into a melt, which then enters a circular die 103. The circular die 103 is provided with a gas inlet passage 104. Through the gas inlet passage 104, gas 105 such as air is blown into the circular die 103, whereupon the melt having passed through the circular die 103 inflates while scaling up in the diametrical direction. Incidentally, the extrusion may be carried out without blowing the gas 105 into the gas inlet passage 104.

The extruded product 106 having thus inflated is drawn upward by means of a pinch roller 108 while being cooled by a cooling ring (not shown). When the it is drawn upward, it passes through the space defined by a dimension stabilizing guide 107, whereby the length in peripheral direction (peripheral length) of the belt is fixed, and also it is cut with a cutter 109 in a desired length, whereby the length in generatrix direction (width) of the belt is fixed.

Thus, the belt-shaped electrophotographic conductive member can be obtained. This process is called the blown-film extrusion (inflation method).

The foregoing description relates to production of a belt of single-layer construction. In the case of a belt of double-layer construction, a second extruder 201 is additionally provided as shown in FIG. 2 (202 denotes a second hopper). A melt from the extruder 101 and a melt from the extruder 201 are simultaneously sent into a circular die 103, and the two layers are scale-up inflated simultaneously, thus the belt of double-layer construction can be obtained. In the case of triple-or more layer construction, the extruder may be provided in the number corresponding to the number of layers.

In the case when the electrophotographic conductive member of the present invention has the shape of a belt, the belt may preferably have a thickness of from 45 μm to 300 μm, more preferably from 50 μm to 270 μm, and still more preferably from 55 μm to 260 μm. If the belt is too thick, it may have a low belt travel performance because of a high rigidity and a poor flexibility to cause deflection or one-sided travel. If on the other hand the belt is too thin, it may have a low tensile strength or may cause elongation as a result of long-term service.

Incidentally, in the above blown-film extrusion, the extrusion material is beforehand obtained and then it is extruded in the shape of a belt, which, however, may be extruded in the shape of a belt through one step.

Next, as a method for producing a roller-shaped electrophotographic conductive member, in particular, an electrophotographic conductive member having the shape in which a roller-shaped support (mandrel) is covered thereon with the thermoplastic resin composition, which has been made in a tubular form, the following methods are available.

They are a method in which materials such as the thermoplastic resin, the conductive filler and the polyhydric alcohol type nonionic surface-active agent are kneaded by means of an open roll or a closed mixer such as a kneader or Banbury mixer, or a twin-screw extruder, and thereafter extruded in a tubular form by an extrusion means such as a single-screw extruder, then the tube obtained is stretched into a tube with a larger inner diameter by utilizing air or vacuum drawing, and the support is press-inserted to the tube to effect fitting; and a method in which, utilizing heat-shrinkable properties of the one extruded in the shape of a tube, the tube is fitted to the roller-shaped support on the inside of which the tube is kept inserted.

In these methods, the materials having been made plastic by heat is passed through between the die and a nipple and thereby extruded in the shape of a tube. The inner-surface roughness of the tube may be adjusted by controlling processing temperature, extrusion speed, rate of pulling, and so forth. It may also be adjusted by providing the die and the nipple with stated shapes.

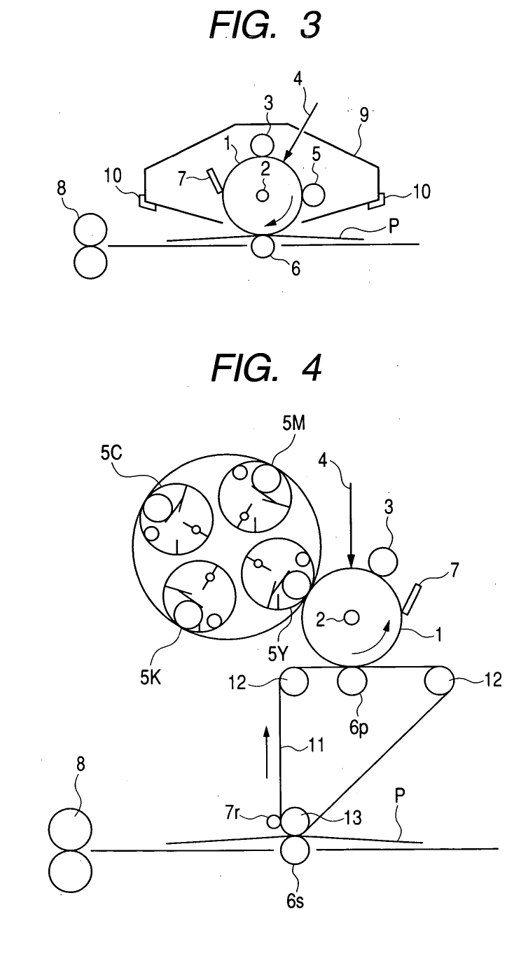

FIG. 3 schematically illustrates the construction of an electrophotographic apparatus.

In FIG. 3, reference numeral 1 denotes a cylindrical electrophotographic photosensitive member, which is rotatingly driven around an axis 2 in the direction of an arrow at a stated peripheral speed.

The surface of the electrophotographic photosensitive member 1 driven rotatingly is uniformly electrostatically charged to a positive or negative, given potential through a primary charging means 3. The electrophotographic photosensitive member thus charged is then exposed to exposure light (imagewise exposure light) 4 emitted from an exposure means (not shown) for slit exposure, laser beam scanning exposure or the like. In this way, electrostatic latent images corresponding to the intended image are successively formed on the surface of the electrophotographic photosensitive member 1.

The electrostatic latent images thus formed on the surface of the electrophotographic photosensitive member 1 are developed with a toner contained in a developer held on a developer carrying member 5, to form toner images (developed images; the same applies hereinafter). Then, the toner images thus formed and held on the surface of the electrophotographic photosensitive member 1 are successively transferred by applying a transfer bias from a transfer charging member 6, to a transfer material (such as paper) P fed from a transfer material feed means (not shown) to the part (contact zone) between the electrophotographic photosensitive member 1 and the transfer charging member 6 in the manner synchronized with the rotation of the electrophotographic photosensitive member 1.

The transfer material P to which the toner images have been transferred is separated from the surface of the electrophotographic photosensitive member 1, is guided into a fixing means 8, where the toner images are fixed, and is then put out of the apparatus as an image-formed material (a print or a copy).

The surface of the electrophotographic photosensitive member 1 from which the toner images have been transferred is brought to removal of the transfer residual developer (toner) through a cleaning member (cleaning blade) 7. Thus, its surface is cleaned. It is further subjected to charge elimination by pre-exposure light (not shown) emitted from a pre-exposure means (not shown), and thereafter repeatedly used for the formation of images. Incidentally, where as shown in FIG. 3 contact charging making use of a roller-shaped primary charging member (primary charging roller) or the like is employed in the charging of the surface of the electrophotographic photosensitive member, the pre-exposure is not necessarily required.

The apparatus may be constituted of a combination of plural components integrally joined in a container as a process cartridge from among the constituents such as the above electrophotographic photosensitive member 1, primary charging member 3, developer carrying member 5, transfer charging member 6 and cleaning member 7 so that the process cartridge is set detachably mountable to the main body of an electrophotographic apparatus such as a copying machine or a laser beam printer. In the apparatus shown in FIG. 3, the electrophotographic photosensitive member 1 and the primary charging member 3, developer carrying member 5 and cleaning member 7 are integrally supported and made into a cartridge to form a process cartridge 9 that is detachably mountable to the main body of the electrophotographic apparatus through a guide means 10 such as rails provided in the main body of the electrophotographic apparatus.

As examples of color electrophotographic apparatus, a color electrophotographic apparatus of an intermediate transfer system and a color electrophotographic apparatus of an in-line system are described next. Incidentally, an example of four colors (yellow, magenta, cyan and black) is given in the following description. The “color” referred to in the present invention is by no means limited to the four color (what is called full-color), and refers to multiple color, i.e., two or more colors.

FIG. 4 schematically illustrates an example of the construction of a color electrophotographic apparatus of an intermediate transfer system. The transfer of toner images from an electrophotographic photosensitive member to a transfer material is chiefly performed by a primary transfer charging member, an intermediate transfer member and a secondary transfer charging member.

In FIG. 4, reference numeral 1 denotes a cylindrical electrophotographic photosensitive member, which is rotatingly driven around an axis 2 in the direction of an arrow at a prescribed peripheral speed.

The surface of the electrophotographic photosensitive member 1 driven rotatingly is uniformly electrostatically charged on its surface to a positive or negative, stated potential through a primary charging member 3. The photosensitive member thus charged is then exposed to exposure light (imagewise exposure light) 4 emitted from an exposure means (not shown) for slit exposure or laser beam scanning exposure. The exposure light used here is exposure light corresponding to a first-color-component image (e.g., a yellow-component image) of an intended color image. Thus, on the surface of the electrophotographic photosensitive member 1, first-color-component electrostatic latent images (yellow-color-component electrostatic latent image) are successively formed which correspond to the first-color-component image of the intended color image.

An intermediate transfer member (intermediate transfer belt) 11 stretched over stretch-over rollers 12 and a secondary-transfer opposing roller 13 is rotatingly driven in the direction of an arrow at substantially the same peripheral speed as the electrophotographic photosensitive member 1 (e.g., at a speed of 97 to 103% in respect to the peripheral speed of the electrophotographic photosensitive member 1).

The first-color-component electrostatic latent images formed on the surface of the electrophotographic photosensitive member 1 are developed with a first-color toner (yellow toner) contained in a developer held by a first-color developer carrying member (yellow developer carrying member) 5Y, to form a first-color toner image (yellow toner image). Then, the first-color toner images formed and held on the surface of the electrophotographic photosensitive member 1 are successively primarily transferred on to the surface of the intermediate transfer member 11 passing through between the electrophotographic photosensitive member 1 and a primary transfer charging member (primary transfer charging roller) 6p, by the aid of a primary transfer bias applied from the primary transfer charging member 6p.

The surface of the electrophotographic photosensitive member 1 from which the first-color toner images have been transferred is cleaned by a cleaning member 7 to remove primary transfer residual developer (toner) to make the surface clean. Thereafter, the photosensitive member thus cleaned is used for the next-color image formation.

Second-color toner images (magenta toner images), third-color toner images (cyan toner images) and fourth-color toner images (black toner images) are formed on the surface of the electrophotographic photosensitive member 1 and then sequentially primarily transferred to the surface of the intermediate transfer member 11, in the same manner as the first-color toner images. Thus, synthesized toner images corresponding to the intended color image are formed on the surface of the intermediate transfer member 11. In the course of the first-color to fourth-color primary transfer, a secondary transfer charging member (secondary transfer charging roller) 6s and a charge-providing member (charge-providing roller) 7r stand separate from the surface of the intermediate transfer member 11.

The synthesized toner images formed on the surface of the intermediate transfer member 11 are successively secondarily transferred on to a transfer material (such as paper) P by the aid of a secondary transfer bias applied from the secondary transfer charging member 6s; the transfer material P being taken out and fed from a transfer material feeding means (not shown) to the part (contact zone) between the secondary-transfer opposing roller 13/intermediate transfer member 11 and the secondary transfer member 6s in the manner synchronized with the rotation of the intermediate transfer member 11.

The transfer material P to which the synthesized toner images have been transferred is separated from the surface of the intermediate transfer member 11 and guided into a fixing means 8, where the synthesized toner images are fixed, and is then put out of the apparatus as a color image-formed matter (a print or a copy).

The charge-providing member 7r is brought into contact with the surface of the intermediate transfer member 11 from which the synthesized toner images have been transferred. The charge-providing member 7r provides the secondary transfer residual developers (toners) held on the surface of the intermediate transfer member 11, with electric charges having a polarity reverse to that at the time of primary transfer. The secondary transfer residual developers (toners) having been provided with electric charges having the polarity reverse to that at the time of primary transfer are electrostatically transferred to the surface of the electrophotographic photosensitive member 1 at the contact zone between the electrophotographic photosensitive member 1 and the intermediate transfer member 11 and the vicinity thereof. Thus, the surface of the intermediate transfer member 11 from which the synthesized toner images have been transferred is cleaned by the removal of the secondary transfer residual developers (toners). The secondary transfer residual developers (toners) having been transferred to the surface of the electrophotographic photosensitive member 1 are removed by the cleaning member 7 together with the primary transfer residual developers (toners) held on the surface of the electrophotographic photosensitive member 1. The transfer of the secondary transfer residual developers (toners) from the intermediate transfer member 11 to the electrophotographic photosensitive member 1 can be performed simultaneously with the primary transfer, and hence the through-put does not lower.

The surface of the electrophotographic photosensitive member 1 from which the transfer residual developers (toners) have been removed by the cleaning member 7 may also be subjected to charge elimination by pre-exposure light emitted from a pre-exposure means. However, where as shown in FIG. 4 contact charging making use of a roller-shaped primary charging member (primary charging roller) or the like is employed in the charging of the surface of the electrophotographic photosensitive member, the pre-exposure is not necessarily required.

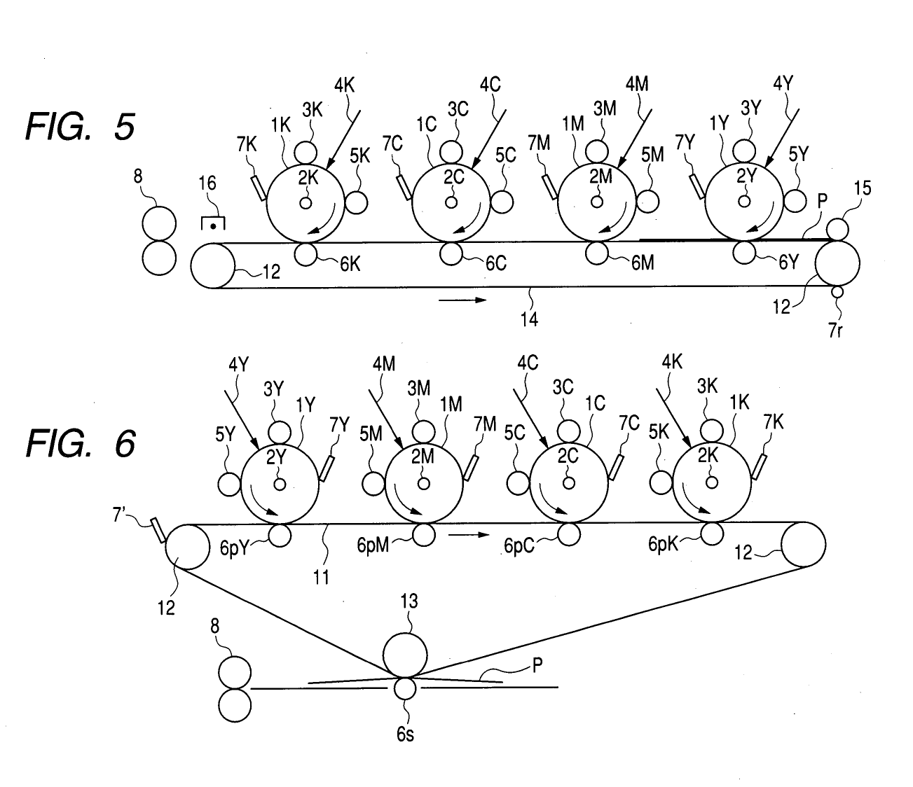

FIG. 5 schematically illustrates an example of the construction of a color electrophotographic apparatus of an in-line system. In the case of this in-line system, the transfer of toner images from an electrophotographic photosensitive member to a transfer material is chiefly performed by a transfer material transport member and a transfer charging member.

In FIG. 5, reference numerals 1Y, 1M, 1C and 1K denote cylindrical electrophotographic photosensitive members (electrophotographic photosensitive members for first color to fourth color), which are rotatingly driven around axes 2Y, 2M, 2C and 2K, respectively, in the directions of arrows at a stated peripheral speed each.

The surface of the electrophotographic photosensitive member 1Y for first color which is rotatingly driven is uniformly electrostatically charged to a positive or negative, given potential through a primary charging member 3Y for first color. The electrophotographic photosensitive member thus charged is then exposed to exposure light (imagewise exposure light) 4Y emitted from an exposure means (not shown) for slit exposure, laser beam scanning exposure or the like. The exposure light 4Y is exposure light corresponding to a first-color-component image (e.g., a yellow-component image) of an intended color image. In this way, first-color-component electrostatic latent images (yellow-component electrostatic latent images) corresponding to the first-color-component image of the intended color image are successively formed on the surface of the electrophotographic photosensitive member 1Y.

A transfer material transport member (transfer material transport belt) 14 stretched over stretch-over rollers 12 are rotatingly driven in the direction of an arrow at substantially the same peripheral speed as the electrophotographic photosensitive members 1Y, 1M, 1C and 1K for first color to fourth color (e.g., 97% to 103% in respect to the peripheral speed of each of the electrophotographic photosensitive members 1Y, 1M, 1C and 1K for first color to fourth color). Also, a transfer material (such as paper) P fed from a transfer material feed means (not shown) is electrostatically held on (attracted to) the transfer material transport member 14, and is successively transported to the parts (contact zones) between the electrophotographic photosensitive members 1Y, 1M, 1C and 1K for first color to fourth color and the transfer material transport member 14.

The first-color-component electrostatic latent images thus formed on the surface of the electrophotographic photosensitive member 1Y for first color are developed with a first-color toner contained in a developer held by a developer carrying member 5Y for first color to form first-color toner images (yellow toner images). Then, the first-color toner images thus formed and held on the surface of the electrophotographic photosensitive member 1Y for first color are successively transferred by the aid of a transfer bias applied from a transfer charging member 6Y for first color (transfer charging roller for first color), and are transferred on to a transfer material P held on the transfer material transport member 14 which passes through between the electrophotographic photosensitive member 1Y for first color and the transfer charging member 6Y for first color.

The surface of the electrophotographic photosensitive member 1Y for first color from which the first-color toner images have been transferred is brought to removal of the transfer residual developer (toner) through a cleaning member 7Y for first color (cleaning blade for first color). Thus, the surface is cleaned, and thereafter the electrophotographic photosensitive member 1Y for first color is repeatedly used for the formation of the first-color toner images.

The electrophotographic photosensitive member 1Y for first color, the primary charging member 3Y for first color, the exposure means for first color, the developer carrying member 5Y for first color and the transfer charging member 6Y for first color are collectively called an image forming section for first color.

An image forming section for second color which has an electrophotographic photosensitive member 1M for second color, a primary charging member 3M for second color, an exposure means for second color, a developer carrying member 5M for second color and a transfer charging member 6M for second color, an image forming section for third color which has an electrophotographic photosensitive member 1C for third color, a primary charging member 3C for third color, an exposure means for third color, a developer carrying member 5C for third color and a transfer charging member 6C for third color, and an image forming section for fourth color which has an electrophotographic photosensitive member 1K for fourth color, a primary charging member 3K for fourth color, an exposure means for fourth color, a developer carrying member 5K for fourth color and a transfer charging member 6K for fourth color are operated in the same way as the operation of the image forming section for first color. Thus, second-color toner images (magenta toner images), third-color toner images (cyan toner images) and fourth-color toner images (black toner images) are transferred on in order, to the transfer material P which is held on the transfer material transport member 14 and to which the first-color toner images have been transferred. In this way, synthesized toner images corresponding to the intended color image are formed on the transfer material P held on the transfer material transport member 14.

The transfer material P on which the synthesized toner images have been formed is separated from the surface of the transfer material transport member 14, is guided into a fixing means 8, where the toner images are fixed, and is then put out of the apparatus as a color-image-formed material (a print or a copy).

The surfaces of the electrophotographic photosensitive members 1Y, 1M, 1C and 1K for first color to fourth color from which the transfer residual developers (toners) have been removed by the cleaning members 7Y, 7M, 7C and 7K, respectively, may also be subjected to charge elimination by pre-exposure light emitted from pre-exposure means. However, where as shown in FIG. 5 contact charging making use of a roller-shaped primary charging member (a primary charging roller) or the like is employed in the charging of the surface of each electrophotographic photosensitive member, the pre-exposure is not necessarily required.

Incidentally, in FIG. 5, reference numeral 15 denotes an attraction roller for attracting the transfer material to the transfer material transport member; and 16, a separation charging assembly for separating the transfer material from the transfer material transport member.

FIG. 6 schematically illustrates another example of the construction of a color electrophotographic apparatus of an intermediate transfer system. In the case of this intermediate transfer system, the transfer of toner images from an electrophotographic photosensitive member to a transfer material is chiefly performed by a primary transfer charging member, an intermediate transfer member and a secondary transfer charging member.

In FIG. 6, reference numerals 1Y, 1M, 1C and 1K denote cylindrical electrophotographic photosensitive members (electrophotographic photosensitive members for first color to fourth color), which are rotatingly driven around axes 2Y, 2M, 2C and 2K, respectively, in the directions of arrows at a stated peripheral speed each.

The surface of the electrophotographic photosensitive member 1Y for first color which is rotatingly driven is uniformly electrostatically charged to a positive or negative, given potential through a primary charging member 3Y for first color. The electrophotographic photosensitive member thus charged is then exposed to exposure light, (imagewise exposure light) 4Y emitted from an exposure means (not shown) for slit exposure, laser beam scanning exposure or the like. The exposure light 4Y is exposure light corresponding to a first-color-component image (e.g., a yellow-component image) of an intended color image. In this way, first-color-component electrostatic latent images (yellow-component electrostatic latent images) corresponding to the first-color-component image of the intended color image are successively formed on the surface of the electrophotographic photosensitive member 1Y.

An intermediate transfer member (intermediate transfer belt) 11 stretched over stretch-over rollers 12 and a secondary-transfer opposing roller 13 are rotatingly driven in the direction of an arrow at substantially the same peripheral speed as the electrophotographic photosensitive members 1Y, 1M, 1C and 1K for first color to fourth color (e.g., 97% to 103% in respect to the peripheral speed of each of the electrophotographic photosensitive members 1Y, 1M, 1C and 1K for first color to fourth color).

The first-color-component electrostatic latent images thus formed on the surface of the electrophotographic photosensitive member 1Y for first color are developed with a first-color toner contained in a developer held on a developer carrying member 5Y for first color to form first-color toner images (yellow toner images). Then, the first-color toner images thus formed and held on the surface of the electrophotographic photosensitive member 1Y for first color are successively primarily transferred by the aid of a primary transfer bias applied from a primary transfer charging member 6pY for first color (primary transfer charging roller for first color), which are transferred on to the surface of the intermediate transfer member 11 which passes the part between the electrophotographic photosensitive member 1Y for first color and the primary transfer member 6pY for first color.

The surface of the electrophotographic photosensitive member 1Y for first color from which the first-color toner images have been transferred is brought to removal of the transfer residual developer (toner) through a cleaning member 7Y for first color (cleaning blade for first color). Thus, the surface is cleaned, and thereafter the electrophotographic photosensitive member 1Y for first color is repeatedly used for the formation of the first-color toner images.

The electrophotographic photosensitive member 1Y for first color, the primary charging member 3Y for first color, the exposure means for first color, the developer carrying member 5Y for first color and the primary transfer charging member 6pY for first color are collectively called an image forming section for first color.

An image forming section for second color which has an electrophotographic photosensitive member 1M for second color, a primary charging member 3M for second color, an exposure means for second color, a developer carrying member 5M for second color and a primary transfer charging member 6pM for second color, an image forming section for third color which has an electrophotographic photosensitive member 1C for third color, a primary charging member 3C for third color, an exposure means for third color, a developer carrying member 5C for third color and a primary transfer charging member 6pC for third color, and an image forming section for fourth color which has an electrophotographic photosensitive member 1K for fourth color, a primary charging member 3K for fourth color, an exposure means for fourth color, a developer carrying member 5K for fourth color and a primary transfer charging member 6pK for fourth color are operated in the same way as the operation of the image forming section for first color. Thus, second-color toner images (magenta toner images), third-color toner images (cyan toner images) and fourth-color toner images (black toner images) are transferred on in order, to the surface of the intermediate transfer member 11. In this way, synthesized toner images corresponding to the intended color image are formed on the surface of the intermediate transfer member 11.

The synthesized toner images formed on the surface of the intermediate transfer member 11 are successively secondarily transferred on to a transfer material (such as paper) P by the aid of a secondary transfer bias applied from a secondary transfer charging member 6s; the transfer material P being taken out and fed from a transfer material feeding means (not shown) to the part (contact zone) between the secondary transfer opposing roller 13/intermediate transfer member 11 and the secondary transfer member 6s in the manner synchronized with the rotation of the intermediate transfer member 11.

The transfer material P to which the synthesized toner images have been transferred is separated from the surface of the intermediate transfer member 11, is guided into a fixing means 8, where the toner images are fixed, and is then put out of the apparatus as a color-image-formed material (a print or a copy).

The surface of the intermediate transfer member 11 from which the synthesized toner images have been transferred is brought to the removal of secondary transfer residual developers (toners) through an intermediate transfer member cleaning member 7′. Thus, its surface is cleaned, and thereafter it is repeatedly used for the formation of the next synthesized toner images.

The surfaces of the electrophotographic photosensitive members 1Y, 1M, 1C and 1K for first color to fourth color from which the transfer residual developers (toners) have been removed by the cleaning members 7Y, 7M, 7C and 7K, respectively, may also be subjected to charge elimination by pre-exposure light emitted from pre-exposure means. However, where as shown in FIG. 6 contact charging making use of a roller-shaped primary charging member (a primary charging roller) or the like is employed in the charging of the surface of each electrophotographic photosensitive member, the pre-exposure is not necessarily required.

The electrophotographic conductive member of the present invention may preferably be used in the above primary charging member, developer carrying member, transfer charging member, primary transfer charging member, intermediate transfer member, secondary transfer charging member, charge-providing member and transfer material transporting member, and the like.

Incidentally, the developing system may preferably be a one-component developing system, and may also preferably be a contact developing system.

The present invention is described below in greater details by giving specific working examples. Note that the present invention is by no means limited to these. In the following Examples, “part(s)” refers to “part(s) by weight.”

### EXAMPLE 1

As materials for the thermoplastic resin composition, the following ones were used.

| | | |
|---|---|---|
| Thermoplastic resin: | | |
| Polyamide 12 | 100 | parts |
| (melt viscosity: MFR = 10) | | |
| Conductive filler: | | |
| Conductive carbon black (1) | 15.5 | parts |
| (trade name: DENKA BLACK granular product, available | | |
| from Denki Kagaku Kogyo Kabushiki Kaisha) | | |
| Polyhydric alcohol type nonionic surface-active | | |
| agent: | | |
| Polyglycerol poly-ricinolate | 0.5 | part |
| (trade name: CHIRABAZOL H-801, available from Taiyo | | |
| Kagaku Co., Ltd.) | | |

The conductive carbon black (1) and the polyglycerol poly-ricinolate were mixed by means of Henschel mixer, and thereafter the polyamide 12 was added and mixed. The mixture obtained was kneaded using a twin-screw extruder, and this was further made into a kneaded product in the form of 2 to 3 mm in particle diameter to obtain an extrusion material.

Next, the extrusion material was introduced into the extruder 101 form the hopper 102 of the apparatus set up as shown in FIG. 1, and then extruded controlling its setting temperature within the range of from 200 to 220° C., to obtain a belt. Its size was adjusted to obtain a belt-shaped electrophotographic conductive member of 160 mm in peripheral length, 230 mm in width and 150 μm in thickness.

The belt-shaped electrophotographic conductive member obtained had a volume resistivity of 1.5×10⁹ Ω·cm and a surface resistivity of 4.5×10⁹ Ω. Also, in both the volume resistivity and the surface resistivity, their maximum values were within 10 times the minimum values in both the peripheral direction and the generatrix direction.

To the belt-shaped electrophotographic conductive member obtained, a voltage of 500 V was applied, where no leak occurred.

The belt-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The belt-shaped electrophotographic conductive member obtained was set as an intermediate transfer belt in the electrophotographic apparatus set up as shown in FIG. 4, and a full-color image reproduction test was conducted in an environment of 15° C./10% RH. As the result, any image density non-uniformity due to resistance non-uniformity of the intermediate transfer belt was not seen from the initial stage, any blank areas caused by poor transfer due to leak or the like was also not seen to have occurred, and any faulty cleaning was also not seen, thus good images were obtainable. Further, a 10,000-sheet running test was conducted, where the intermediate transfer belt maintained the same surface properties as those at the initial stage without causing any filming of toner on its surface. Here, an elastic roller having a surface resistivity of 1×10⁸ Ω was used as the charge-providing member.

Using the electrophotographic apparatus set up as shown in FIG. 4, a belt-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the belt-shaped electrophotographic conductive member and the electrophotographic photosensitive member were kept in contact. Also, the surface resistivity of the belt-shaped electrophotographic conductive member having been left for a month was 3.8×10⁹ Ω, which little differed from the value before contact. Thus, the electrophotographic conductive member was seen to be one which caused no change in performance even when left in a severe environment.

### EXAMPLE 2

A belt-shaped electrophotographic conductive member was produced in the same manner as in Example 1 except that the following materials were used as materials for the thermoplastic resin composition.

| | | |
|---|---|---|
| Thermoplastic resin: | | |
| Polyamide 12 | 100 | parts |
| (melt viscosity: MFR = 10) | | |
| Conductive filler: | | |
| Conductive carbon black (2) | 4.5 | parts |
| (trade name: KETJEN BLACK EC600JD, available from | | |
| Lion Corporation) | | |
| Polyhydric alcohol type nonionic surface-active | | |
| agent: | | |
| Polyglycerol stearate | 0.8 | part |
| (trade name: CHIRABAZOL P-4, available from Taiyo | | |
| Kagaku Co., Ltd.) | | |

The belt-shaped electrophotographic conductive member obtained had a volume resistivity of 3.4×10⁹ Ω·cm and a surface resistivity of 6.2×10⁹ Ω. Also, in both the volume resistivity and the surface resistivity, their maximum values were within 15 times the minimum values in both the peripheral direction and the generatrix direction.

To the belt-shaped electrophotographic conductive member obtained, a voltage of 500 V was applied, where no leak occurred.

The belt-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The belt-shaped electrophotographic conductive member obtained was set as an intermediate transfer belt in the electrophotographic apparatus set up as shown in FIG. 4, and a full-color image reproduction test was conducted in an environment of 15° C./10% RH. As the result, any image density non-uniformity due to resistance non-uniformity of the intermediate transfer belt was not seen from the initial stage, any blank areas caused by poor transfer due to leak or the like was also not seen to have occurred, and any faulty cleaning was also not seen, thus good images were obtainable. Further, a 10,000-sheet running test was conducted, where the intermediate transfer belt maintained the same surface properties as those at the initial stage without causing any filming of toner on its surface.

Using the electrophotographic apparatus set up as shown in FIG. 4, a belt-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the belt-shaped electrophotographic conductive member and the electrophotographic photosensitive member were kept in contact. Also, the surface resistivity of the belt-shaped electrophotographic conductive member having been left for a month was 6.0×10⁹ Ω, which little differed from the value before contact. Thus, the electrophotographic conductive member was seen to be one which caused no change in performance even when left in a severe environment.

### EXAMPLE 3

A belt-shaped electrophotographic conductive member was produced in the same manner as in Example 1 except that the following materials were used as materials for the thermoplastic resin composition and that the belt was formed in a size of 180 mm in peripheral length, 230 mm in width and 150 μm in thickness.

| | | |
|---|---|---|
| Thermoplastic resin: | | |
| Polyamide 12 | 100 | parts |
| (melt viscosity: MFR = 10) | | |
| Conductive filler: | | |
| Conductive carbon black (2) | 4.3 | parts |
| (trade name: KETJEN BLACK EC600JD, available from | | |
| Lion Corporation) | | |
| Polyhydric alcohol type nonionic surface-active | | |
| agent: | | |
| Polyglycerol stearate | 0.8 | part |
| (trade name: CHIRABAZOL P-4, available from Taiyo | | |
| Kagaku Co., Ltd.) | | |

The belt-shaped electrophotographic conductive member obtained had a volume resistivity of 6.4×10⁹ Ω·cm and a surface resistivity of 8.1×10⁹ Ω. Also, in both the volume resistivity and the surface resistivity, their maximum values were within 15 times the minimum values in both the peripheral direction and the generatrix direction.

To the belt-shaped electrophotographic conductive member obtained, a voltage of 500 V was applied, where no leak occurred.

The belt-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The belt-shaped electrophotographic conductive member obtained was set as an intermediate transfer belt in the electrophotographic apparatus set up as shown in FIG. 6, and a full-color image reproduction test was conducted in an environment of 15° C./10% RH. As the result, any image density non-uniformity due to resistance non-uniformity of the intermediate transfer belt was not seen from the initial stage, any blank areas caused by poor transfer due to leak or the like was also not seen to have occurred, and any faulty cleaning was also not seen, thus good images were obtainable. Further, a 10,000-sheet running test was conducted, where the intermediate transfer belt maintained the same surface properties as those at the initial stage without causing any filming of toner on its surface.

Using the electrophotographic apparatus set up as shown in FIG. 6, a belt-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the belt-shaped electrophotographic conductive member and the electrophotographic photosensitive member were kept in contact. Also, the surface resistivity of the belt-shaped electrophotographic conductive member having been left for a month was 7.5×10⁹ Ω, which little differed from the value before contact. Thus, the electrophotographic conductive member was seen to be one which caused no change in performance even when left in a severe environment.

### EXAMPLE 4

A belt-shaped electrophotographic conductive member was produced in the same manner as in Example 1 except that the following materials were used as materials for the thermoplastic resin composition and that the belt was formed in a size of 200 mm in peripheral length, 260 mm in width and 100 μm in thickness.

| | | |
|---|---|---|
| Thermoplastic resin: | | |
| Polyamide 12 | 100 | parts |
| (melt viscosity: MFR = 10) | | |
| Conductive filler: | | |
| Conductive carbon black (2) | 3.7 | parts |
| (trade name: KETJEN BLACK EC600JD, available from | | |
| Lion Corporation) | | |
| Polyhydric alcohol type nonionic surface-active | | |
| agent: | | |
| Polyglycerol stearate | 0.7 | part |
| (trade name: CHIRABAZOL P-4, available from Taiyo | | |
| Kagaku Co., Ltd.) | | |

The belt-shaped electrophotographic conductive member obtained had a volume resistivity of 5.7×10¹¹ Ω·cm and a surface resistivity of 7.1×10¹¹ Ω. Also, in both the volume resistivity and the surface resistivity, their maximum values were within 30 times the minimum values in both the peripheral direction and the generatrix direction.

To the belt-shaped electrophotographic conductive member obtained, a voltage of 500 V was applied, where no leak occurred.

The belt-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The belt-shaped electrophotographic conductive member obtained was set as a transfer material transporting belt in the electrophotographic apparatus set up as shown in FIG. 5, and a full-color image reproduction test was conducted in an environment of 15° C./10% RH. As the result, any image density non-uniformity due to resistance non-uniformity of the transfer material transporting belt was not seen from the initial stage, any blank areas caused by poor transfer due to leak or the like was also not seen to have occurred, and any faulty cleaning was also not seen, thus good images were obtainable. Further, a 10,000-sheet running test was conducted, where the transfer material transporting belt maintained the same surface properties as those at the initial stage without causing any filming of toner on its surface.

Using the electrophotographic apparatus set up as shown in FIG. 5, a belt-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the belt-shaped electrophotographic conductive member and the electrophotographic photosensitive member were kept in contact. Also, the surface resistivity of the belt-shaped electrophotographic conductive member having been left for a month was 5.9×10¹¹ Ω, which little differed from the value before contact. Thus, the electrophotographic conductive member was seen to be one which caused no change in performance even when left in a severe environment.

### EXAMPLE 5

To 100 parts of silicone rubber, 15 parts of conductive carbon black, 20 parts of dimethylsilicone oil, 6 parts of a blowing agent (AIBN, 2,2′-azobisisobutyronitrile) and 3 parts of a cross-linking agent (benzoyl peroxide) were added, and the mixture obtained was kneaded to prepare a conductive rubber compound.

Using this conductive rubber compound, vulcanization blowing molding was carried out on the periphery of a stainless steel cylinder (support) of 332 mm in length and 6 mm in diameter. Thereafter, the outer periphery of the product obtained was abraded to produce a conductive rubber roller of 14 mm in outer diameter, 4.0 mm in thickness of a foam and 311 mm in axial-direction length of the foam.

Meanwhile, a seamless tube was produced using the following materials as materials for the thermoplastic resin composition.

| | | |
|---|---|---|
| Thermoplastic resins: | | |
| Styrene ethylene butylene elastomer | 75 | parts |
| Polypropylene | 25 | parts |
| Conductive filler: | | |
| Conductive carbon black (1) | 17.5 | parts |
| (trade name: DENKA BLACK granular product, | | |
| available from Denki Kagaku Kogyo Kabushiki Kaisha) | | |
| Polyhydric alcohol type nonionic surface-active | | |
| agent: | | |
| Polyglycerol poly-ricinolate | 1.0 | part |
| (trade name: CHIRABAZOL H-818, available from Taiyo | | |
| Kagaku Co., Ltd.) | | |

More specifically, the styrene ethylene butylene elastomer, the polypropylene, the conductive carbon black (1) and the polyglycerol poly-ricinolate were melt-kneaded at 180° C. for 10 minutes by means of a pressure kneader. The kneaded product obtained was cooled, and then pelletized. Thereafter, the pelletized product was kneaded using a single-screw extruder to make up a kneaded product in the form of pellets of 2 to 3 mm in particle diameter to obtain an extrusion material.

Next, from this extrusion material, a seamless tube of 13.6 mm in inner diameter and 230 μm in thickness was produced using a single-screw extruder set at 170° C.

Air was blown to the inside of the above seamless tube to stretch it into a tube with a larger inner diameter of 14.5 mm. Thereafter, the above conductive rubber roller was inserted thereto to effect fitting to obtain a roller-shaped electrophotographic conductive member of 14 mm in diameter.

The roller-shaped electrophotographic conductive member obtained had a volume resistivity of 8.5×10⁶ Ω·cm and a surface resistivity of 3.3×10⁷ Ω. Also, in both the volume resistivity and the surface resistivity, their maximum values were within 10 times the minimum values in both the peripheral direction and the generatrix direction.

To the roller-shaped electrophotographic conductive member obtained, a voltage of 500 V was applied, where no leak occurred.

The roller-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The roller-shaped electrophotographic conductive member obtained was set as a primary charging roller in the electrophotographic apparatus set up as shown in FIG. 3, and an image reproduction test was conducted in an environment of 15° C./10% RH. As the result, any image density non-uniformity due to resistance non-uniformity of the primary charging roller was not seen from the initial stage, and good images were obtainable. Here, to the primary charging roller, bias voltage was applied under conditions of a peak-to-peak voltage of 2.3 kV. a frequency of 400 Hz and a DC voltage of −700 V.

Using the process cartridge of the electrophotographic apparatus set up as shown in FIG. 3, a roller-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the roller-shaped electrophotographic conductive member and the electrophotographic photosensitive member were kept in contact. Also, the surface resistivity of the roller-shaped electrophotographic conductive member having been left for a month was 1.8×10⁷ Ω, which little differed from the value before contact. Thus, the electrophotographic conductive member was seen to be one which caused no change in performance even when left in a severe environment.

### EXAMPLE 6

A seamless tube was produced in the same manner as in Example 5 except that the following materials were used as materials for the thermoplastic resin composition. A roller-shaped electrophotographic conductive member was also produced in the same manner as in Example 5.

| | | |
|---|---|---|
| Thermoplastic resins: | | |
| Styrene ethylene butylene elastomer | 75 | parts |
| Polypropylene | 25 | parts |
| Conductive filler: | | |
| Conductive carbon black (1) | 17.5 | parts |
| (trade name: DENKA BLACK granular product, | | |
| available from Denki Kagaku Kogyo Kabushiki Kaisha) | | |
| Polyhydric alcohol type nonionic surface-active | | |
| agent: | | |
| Polyglycerol stearate | 2.0 | parts |
| (trade name: CHIRABAZOL P-4, available from Taiyo | | |
| Kagaku Co., Ltd.) | | |

The roller-shaped electrophotographic conductive member obtained had a volume resistivity of 9.1×10⁶ Ω·cm and a,surface resistivity of 4.8×10⁷ Ω. Also, in both the volume resistivity and the surface resistivity, their maximum values were within 20 times the minimum values in both the peripheral direction and the generatrix direction.

To the roller-shaped electrophotographic conductive member obtained, a voltage of 500 V was applied, where no leak occurred.

The roller-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The roller-shaped electrophotographic conductive member obtained was set as a primary charging roller in the electrophotographic apparatus set up as shown in FIG. 3, and an image reproduction test was conducted in an environment of 15° C./10% RH. As the result, any image density non-uniformity due to resistance non-uniformity of the primary charging roller was not seen from the initial stage, and good images were obtainable. Here, to the primary charging roller, bias voltage was applied under conditions of a peak-to-peak voltage of 2.3 kV. a frequency of 400 Hz and a DC voltage of −700 V.

Using the process cartridge of the electrophotographic apparatus set up as shown in FIG. 3, a roller-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the roller-shaped electrophotographic conductive member and the electrophotographic photosensitive member were kept in contact. Also, the surface resistivity of the roller-shaped electrophotographic conductive member having been left for a month was 3.7×10⁷ Ω, which little differed from the value before contact. Thus, the electrophotographic conductive member was seen to be one which caused no change in performance even when left in a severe environment.

### EXAMPLE 7

To acrylic rubber, additive such as conductive carbon black and vulcanization accelerator were added, and the mixture obtained was kneaded by means of a two-roll mill to produce a conductive rubber compound.

This conductive rubber compound was wound around an iron cylinder (support) which had been coated with a primer on its surface, and this was put into a mold, followed by vulcanization at 170° C. for 25 minutes to produce a semiconductive elastic roller.

Meanwhile, a seamless tube was produced using the following materials as materials for the thermoplastic resin composition.

| | | |
|---|---|---|
| Thermoplastic resins: | | |
| Polyethylene (melt viscosity: MFR = 2) | 75 | parts |
| Polypropylene | 25 | parts |
| Conductive filler: | | |
| Conductive carbon black (1) | 18.5 | parts |
| (trade name: DENKA BLACK granular product, | | |
| available from Denki Kagaku Kogyo Kabushiki Kaisha) | | |
| Polyhydric alcohol type nonionic surface-active | | |
| agent: | | |
| Polyglycerol poly-ricinolate | 1.0 | part |
| (trade name: CHIRABAZOL H-818, available from Taiyo | | |
| Kagaku Co., Ltd.) | | |
| PMMA (polymethyo methacrylate) prticles | 10 | parts |
| (average particle diameter: 7.5 μm; true density: | | |
| 1.19 g/cm3; length/breadth: 1.06) | | |

More specifically, the polyethylene, the polypropylene, the conductive carbon black (1), the polyglycerol poly-ricinolate and the PMMA prticles were melt-kneaded at 180° C. for 10 minutes by means of a pressure kneader. The kneaded product obtained was cooled, and then pelletized. Thereafter, the pelletized product was kneaded using a single-screw extruder to make up a kneaded product in the form of 2 to 3 mm in particle diameter to obtain an extrusion material.

Next, from this extrusion material, a seamless tube of 13.6 mm in inner diameter and 230 μm in thickness was produced using a single-screw extruder set at 170° C.

Air was blown to the inside of the above seamless tube to stretch it into a tube with a larger inner diameter of 14.5 mm. Thereafter, the above semiconductive elastic rubber roller was inserted thereto to effect fitting to obtain a roller-shaped electrophotographic conductive member of 14 mm in diameter.

The roller-shaped electrophotographic conductive member obtained had a volume resistivity of 5.1×10⁵ Ω·cm and a surface resistivity of 9.4×10⁵ Ω. Also, in both the volume resistivity and the surface resistivity, their maximum values were within 10 times the minimum values in both the peripheral direction and the generatrix direction.

To the roller-shaped electrophotographic conductive member obtained, a voltage of 500 V was applied, where no leak occurred.

The roller-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The roller-shaped electrophotographic conductive member obtained was set as a developing roller in the electrophotographic apparatus set up as shown in FIG. 4, and a full-color image reproduction test was conducted in an environment of 15° C./10% RH. As the result, any image density non-uniformity due to resistance non-uniformity of the developing roller was not seen from the initial stage, and good images were obtainable. Incidentally, as the above roller-shaped electrophotographic conductive member, four members were prepared, and these were used as the four developing rollers of the electrophotographic apparatus set up as shown in FIG. 4.

Using the electrophotographic apparatus set up as shown in FIG. 4, a roller-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the roller-shaped electrophotographic conductive member and the electrophotographic photosensitive member were kept in contact. Also, the surface resistivity of the roller-shaped electrophotographic conductive member having been left for a month was 8.2×10⁵ Ω, which little differed from the value before contact. Thus, the electrophotographic conductive member was seen to be one which caused no change in performance even when left in a severe environment.

### EXAMPLE 8

A seamless tube was produced in the same manner as in Example 7 except that the following materials were used as materials for the thermoplastic resin composition. A roller-shaped electrophotographic conductive member was also produced in the same manner as in Example 7.

| | | |
|---|---|---|
| Thermoplastic resins: | | |
| Polyethylene (melt viscosity: MFR = 2) | 75 | parts |
| Polypropylen | 25 | parts |
| Conductive filler: | | |
| Conductive carbon black (1) | 16.5 | parts |
| (trade name: DENKA BLACK granular product, | | |
| available from Denki Kagaku Kogyo Kabushiki Kaisha) | | |
| Polyhydric alcohol type nonionic surface-active | | |
| agent: | | |
| Polyglycerol stearate | 2.0 | parts |
| (trade name: CHIRABAZOL P-4, available from Taiyo | | |
| Kagaku Co., Ltd.) | | |
| PMMA (polymethyl methacrylate) particles | 10 | parts |
| (average particle diameter: 7.5 μm; true density: | | |
| 1.19 g/cm³; length/breadth: 1.06) | | |

The roller-shaped electrophotographic conductive member obtained had a volume resistivity of 6.9×10⁵ Ω·cm and a surface resistivity of 2.2×10⁶ Ω. Also, in both the volume resistivity and the surface resistivity, their maximum values were within 30 times the minimum values in both the peripheral direction and the generatrix direction.

To the roller-shaped electrophotographic conductive member obtained, a voltage of 500 V was applied, where no leak occurred.

The roller-shaped electrophotographic conductive member obtained was visually observed. As the result, neither foreign matter such as pimples or fish eyes nor any sign of faulty extrusion was seen on the surface. This is considered due to the fact that the polyhydric alcohol type nonionic surface-active agent brought so high dispersion effect as to cause no agglomerate of the conductive filler.

The roller-shaped electrophotographic conductive member obtained was set as a developing roller in the electrophotographic apparatus set up as shown in FIG. 4, and a full-color image reproduction test was conducted in an environment of 15° C./10% RH. As the result, any image density non-uniformity due to resistance non-uniformity of the developing roller was not seen from the initial stage, and good images were obtainable. Incidentally, as the above roller-shaped electrophotographic conductive member, four members were prepared, and these were used as the four developing rollers of the electrophotographic apparatus set up as shown in FIG. 4.

Using the electrophotographic apparatus set up as shown in FIG. 4, a roller-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, the surface of the electrophotographic photosensitive member was seen not to have been contaminated. Thereafter, image reproduction was tested. As the result, any faulty images such as black lines and white areas were not seen at the part corresponding to the part where the roller-shaped electrophotographic conductive member and the electrophotographic photosensitive member were kept in contact. Also, the surface resistivity of the roller-shaped electrophotographic conductive member having been left for a month was 1.4×10⁶ Ω, which little differed from the value before contact. Thus, the electrophotographic conductive member was seen to be one which caused no change in performance even when left in a severe environment.

### COMPARATIVE EXAMPLE 1

A belt-shaped electrophotographic conductive member was produced in the same manner as in Example 1 except that the polyhydric alcohol type nonionic surface-active agent was not used.

The belt-shaped electrophotographic conductive member obtained had a volume resistivity of 3.2×10⁸ Ω·cm and a surface resistivity of 6.5×10⁸ Ω. Also, in both the volume resistivity and the surface resistivity, their maximum values were 800 times the minimum values in both the peripheral direction and the generatrix direction. This is considered due to the fact that the conductive carbon black stood dispersed non-uniformly.

To the belt-shaped electrophotographic conductive member obtained, a voltage of 500 V was applied, where a leak due to pimples occurred. Sections of the pimples of the belt-shaped electrophotographic conductive member were observed. As the result, agglomerates of the conductive carbon black were seen.

The belt-shaped electrophotographic conductive member obtained was set as an intermediate transfer belt in the electrophotographic apparatus set up as shown in FIG. 4, and a full-color image reproduction test was conducted in an environment of 15° C./10% RH. As the result, transfer efficiency (the product of primary transfer efficiency and secondary transfer efficiency) was 90% at a maximum and 80% at a minimum, thus the transfer efficiency was insufficient and transfer non-uniformity was also seen. In particular, the transfer was insufficient at pimple areas, and blank areas appeared at the part corresponding to the pimple areas.

### COMPARATIVE EXAMPLE 2

A belt-shaped electrophotographic conductive member was produced in the same manner as in Example 1 except that 0.5 part of the polyhydric alcohol type nonionic surface-active agent polyglycerol poly-ricinolate was changed for 1.5 parts of beef tallow diamine dioleate.

The belt-shaped electrophotographic conductive member obtained had a volume resistivity of 8.5×10⁸ Ω·cm and a surface resistivity of 9.8×10⁸ Ω. Also, in both the volume resistivity and the surface resistivity, their maximum values were 150 times the minimum values in both the peripheral direction and the generatrix direction. This is considered due to the fact that the conductive carbon black stood dispersed non-uniformly.

To the belt-shaped electrophotographic conductive member obtained, a voltage of 500 V was applied, where a leak due to pimples occurred. Sections of the pimples of the belt-shaped electrophotographic conductive member were observed. As the result, agglomerates of the conductive carbon black were seen.

The belt-shaped electrophotographic conductive member obtained was set as an intermediate transfer belt in the electrophotographic apparatus set up as shown in FIG. 4, and a full-color image reproduction test was conducted in an environment of 15° C./10% RH. As the result, transfer efficiency (the product of primary transfer efficiency and secondary transfer efficiency) was 92% at a maximum and 85% at a minimum, thus the transfer efficiency was insufficient and transfer non-uniformity was also seen. In particular, the transfer was insufficient at pimple areas, and blank areas appeared at the part corresponding to the pimple areas.

Using the electrophotographic apparatus set up as shown in FIG. 4, a belt-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, white lines were seen on the surface of the electrophotographic photosensitive member. Thereafter, image reproduction was tested. As the result, line-shaped faulty images appeared at the part corresponding to the part where the belt-shaped electrophotographic conductive member and the electrophotographic photosensitive member were kept in contact. This electrophotographic photosensitive member was observed. As the result, fine cracks were seen to have occurred on the surface. Also, the surface resistivity of the belt-shaped electrophotographic conductive member having been left for a month was 5.9×10⁷ Ω, which differed greatly from the value before contact. Thus, the electrophotographic conductive member was seen to be one which caused changes in performance when left in a severe environment. As the result of the leaving for a month, the transfer efficiency was further lowered so that it was 80% at a maximum and 72% at a minimum.

### COMPARATIVE EXAMPLE 3

A belt-shaped electrophotographic conductive member was produced in the same manner as in Example 3 except that the polyhydric alcohol type nonionic surface-active agent was not used.

The belt-shaped electrophotographic conductive member obtained had a volume resistivity of 3.4×10⁹ Ω·cm and a surface resistivity of 4.6×10⁹ Ω. Also, in both the volume resistivity and the surface resistivity, their maximum values were 150 times the minimum values in both the peripheral direction and the generatrix direction. This is considered due to the fact that the conductive carbon black stood dispersed non-uniformly.

The belt-shaped electrophotographic conductive member obtained was set as an intermediate transfer belt in the electrophotographic apparatus set up as shown in FIG. 6, and a full-color image reproduction test was conducted in an environment of 15° C./10% RH. As the result, transfer efficiency (the product of primary transfer efficiency and secondary transfer efficiency) was 92% at a maximum and 85% at a minimum, thus the transfer efficiency was insufficient and transfer non-uniformity was also seen. In particular, the transfer was insufficient at pimple areas, and blank areas appeared at the part corresponding to the pimple areas.

### COMPARATIVE EXAMPLE 4

A belt-shaped electrophotographic conductive member was produced in the same manner as in Example 4 except that 0.7 part of the polyhydric alcohol type nonionic surface-active agent condensed polyglycerol stearate was changed for 1.5 parts of beef tallow diamine dioleate.

The belt-shaped electrophotographic conductive member obtained had a volume resistivity of 8.1×10¹⁰ Ω·cm and a surface resistivity of 1.3×10¹¹ Ω. Also, in both the volume resistivity and the surface resistivity, their maximum values were 120 times the minimum values in both the peripheral direction and the generatrix direction. This is considered due to the fact that the conductive carbon black stood dispersed non-uniformly.

The belt-shaped electrophotographic conductive member obtained was set as a transfer material transporting belt in the electrophotographic apparatus set up as shown in FIG. 5, and a full-color image reproduction test was conducted in an environment of 15° C./10% RH. As the result, image density non-uniformity due to resistance non-uniformity of the transfer material transporting belt appeared from the initial stage, and blank areas caused by poor transfer due to leak also appeared, thus no good images were obtainable. Further, a 10,000-sheet running test was conducted, where filming of toner occurred on the surface of the transfer material transporting belt.

Using the electrophotographic apparatus set up as shown in FIG. 5, a belt-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, white lines were seen on the surface of the electrophotographic photosensitive member. Thereafter, image reproduction was tested. As the result, line-shaped faulty images appeared at the part corresponding to the part where the belt-shaped electrophotographic conductive member and the electrophotographic photosensitive member were kept in contact. This electrophotographic photosensitive member was observed. As the result, fine cracks were seen to have occurred on the surface. Also, the surface resistivity of the belt-shaped electrophotographic conductive member having been left for a month was 3.3×10⁸ Ω, which differed greatly from the value before contact. Thus, the electrophotographic conductive member was seen to be one which caused changes in performance when left in a severe environment. Also, as a result of a lowering of surface resistivity, the ability to attract and hold transfer materials lowered to cause aberration of images.

### COMPARATIVE EXAMPLE 5

A seamless tube was produced in the same manner as in Example 5 except that 0.5 part of the polyhydric alcohol type nonionic surface-active agent polyglycerol poly-ricinolate was changed for 1.5 parts of beef tallow diamine dioleate. Also, a roller-shaped electrophotographic conductive member was produced in the same manner as in Example 5.

The roller-shaped electrophotographic conductive member obtained had a volume resistivity of 7.7×10⁶ Ω·cm and a surface resistivity of 8.7×10⁶ Ω. Also, in both the volume resistivity and the surface resistivity, their maximum values were 130 times the minimum values in both the peripheral direction and the generatrix direction.

The roller-shaped electrophotographic conductive member obtained was set as a primary charging roller in the electrophotographic apparatus set up as shown in FIG. 3, and an image reproduction test was conducted in an environment of 15° C./10% RH. As the result, image density non-uniformity due to resistance non-uniformity of the primary charging roller appeared from the initial stage. Here, to the primary charging roller, bias voltage was applied under conditions of a peak-to-peak voltage of 2.3 kV. a frequency of 400 Hz and a DC voltage of −700 V.

Using the process cartridge of the electrophotographic apparatus set up as shown in FIG. 3, a roller-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, white lines were seen on the surface of the electrophotographic photosensitive member. Thereafter, image reproduction was tested. As the result, line-shaped faulty images appeared at the part corresponding to the part where the roller-shaped electrophotographic conductive member and the electrophotographic photosensitive member were kept in contact. This electrophotographic photosensitive member was observed. As the result, fine cracks were seen to have occurred on the surface.

### COMPARATIVE EXAMPLE 6

A seamless tube was produced in the same manner as in Example 7 except that 1.0 part of the polyhydric alcohol type nonionic surface-active agent polyglycerol poly-ricinolate was changed for 1.5 parts of beef tallow diamine dioleate. Also, a roller-shaped electrophotographic conductive member was produced in the same manner as in Example 7.

The roller-shaped electrophotographic conductive member obtained had a volume resistivity of 3.8×10⁵ Ω·cm and a surface resistivity of 6.2×10⁵ Ω. Also, in both the volume resistivity and the surface resistivity, their maximum values were 150 times the minimum values in both the peripheral direction and the generatrix direction.

The roller-shaped electrophotographic conductive member obtained was set as a developing roller in the electrophotographic apparatus set up as shown in FIG. 4, and a full-color image reproduction test was conducted in an environment of 15° C./10% RH. As the result, image density non-uniformity due to resistance non-uniformity of the developing roller appeared from the initial stage. Incidentally, as the above roller-shaped electrophotographic conductive member, four members were prepared, and these were used as the four developing rollers of the electrophotographic apparatus set up as shown in FIG. 4.

Using the electrophotographic apparatus set up as shown in FIG. 4, a roller-shaped electrophotographic conductive member also produced in the same manner as the above was brought into contact with the electrophotographic photosensitive member, and these were left for a month in an environment of 40° C./95% RH, and thereafter the electrophotographic photosensitive member was visually observed. As the result, white lines were seen on the surface of the electrophotographic photosensitive member. Thereafter, image reproduction was tested. As the result, line-shaped faulty images appeared at the part corresponding to the part where the roller-shaped electrophotographic conductive member and the electrophotographic photosensitive member were kept in contact. This electrophotographic photosensitive member was observed. As the result, fine cracks were seen to have occurred on the surface.

This application claims priority from Japanese Patent Application No. 2003-399886 filed on Nov. 28, 2003, which is hereby incorporated by reference herein.

1. An electrophotographic conductive member comprising a thermoplastic resin composition, wherein;
said thermoplastic resin composition contains a thermoplastic resin, a conductive filler and a conductive-filler dispersing agent, and the conductive-filler dispersing agent is a polyhydric alcohol type nonionic surface-active agent.

2. The electrophotographic conductive member according to claim 1, wherein said polyhydric alcohol type nonionic surface-active agent is a glycerol fatty ester.

3. The electrophotographic conductive member according to claim 2, wherein said glycerol fatty ester is polyglycerol poly-ricinolate.

4. The electrophotographic conductive member according to claim 2, wherein said glycerol fatty ester is polyglycerol stearate.

5. The electrophotographic conductive member according to claim 1, wherein said conductive filler is carbon black.

6. The electrophotographic conductive member according to claim 1, wherein said dispersing agent is contained in said thermoplastic resin composition in an amount of from 1% by weight to 20% by weight based on the weight of the conductive filler in said thermoplastic resin composition.

7. The electrophotographic conductive member according to claim 1, which has the shape of a belt.

8. The electrophotographic conductive member according to claim 7, which is a transfer material transporting belt.

9. The electrophotographic conductive member according to claim 1, which has the shape of a roller.

10. An electrophotographic apparatus comprising an electrophotographic conductive member comprising a thermoplastic resin composition, wherein;
said thermoplastic resin composition contains a thermoplastic resin, a conductive filler and a conductive-filler dispersing agent, and the conductive-filler dispersing agent is a polyhydric alcohol type nonionic surface-active agent.
